(19) United States
(12) Patent Application Publication
(10) Pub. No.: US 2003/0175428 A1
(43) Pub. Date: Sep. 18, 2003

(54) Member for linking together articles during coating and according process

(76) Inventor: David Charles Payne, Old Buckenham (GB)

Correspondence Address: Thomas M Galgano, Galgano & Burke, Suite 135, 300 Rabro Drive, Hauppauge, NY, 11788, US

(21) Appl. No.: 10/362,797

(22) PCT Filed: Aug. 28, 2001
(86) PCT No.: PCT/GB01/03842

(30) Foreign Application Priority Data
Oct. 31, 2000 (GB) 00265496

(51) Int. Cl. B05D 3/12

(52) U.S. Cl. 427/293

(57) ABSTRACT

The invention relates to a linkage member (10) for linking articles together during a process for coating the articles. The linkage member (10) has a first and second end (12), each end (12) of which is configured to receive and about end portions of successive articles to be coated and to prevent coating of the end portions. Each linkage member (10) is primarily formed from a material such as a perfluorinated polymer, which imparts low thermal conductivity to the linkage member (10). An outer layer of conductive material, such as steel, can be provided to enable heat to be transferred rapidly across the surface of the linkage member (10). The linkage member (10) can he substantially cylindrical in shape with at typical diameter of 15-30 mm and height of 12-15 mm.

### FIELD OF THE INVENTION

The invention relates to an apparatus and methods for coating an article with a thermoplastic material. The apparatus and methods are particularly suited for coating elongate products such as fluorescent lamps or handles for implements such as brooms or rakes.

### BACKGROUND TO THE INVENTION

In the production of many manufactured articles, a step in the production of that article is to apply a coating of a material to the article. Coating can be carried out for a number of reasons. For example, the article may be formed, at least in part, of materials which are unstable in the environment in which the article is to be used. In this instance the coating acts as a barrier. Alternatively, the coating may be applied for aesthetic reasons to improve the finish of the article. Furthermore, a coating can also be applied to improve the safety parameters of an article. Examples of this type of coating are heat resistant coatings to improve the fire retardant characteristics of an article as well as coatings which can impart impact resistance or in the case of an article which shatters easily, retain fragments of the article should it become broken.

Particular examples of a type of product with which the present invention is chiefly, but not exclusively concerned are light bulbs or fluorescent lighting tubes, which comprise substantially in their entirety a glass body. The principle reason for coating a bulb or tube with a protective material is to improve the safety parameters. Should the glass in the bulb or tube shatter, the coating retains fragments of glass which could cause physical injury or, where the glass is coated with a phosphor powder, pose a health risk. Normally polymeric materials are used as coatings which, depending on the type of light emitted, absorb little visible and/or ultraviolet light, do not melt or flow at the in-use temperature of the bulb or tube and are not readily degraded by the emitted radiation.

A known process for coating an article such as a light bulb or tube is to form an expanded film of a coating material about the article and then allow the film to shrink and bond to the surface of the article. The principal drawback with this process is that the selection of a suitable polymer is limited to those having properties which enable the polymer to expand and shrink when required. Furthermore, using the above process, articles must be coated in isolation from other articles and the process is therefore slow.

A further known process is to pass the article to which a coating is to be applied through a cross-head extruder. The extruder coats the article with a thermoplastic material which has a sufficiently low viscosity to enable the coating to flow about the article and thus coat it. The disadvantage of this process is that the articles are either passed through singly, or in end-to-end abutment. The former is slow and yields an article with coating over its ends, which is therefore unsuitable where end-coating is not desirable. The latter leads however, to poor and non-reproducible end-coating when the articles are separated from one another.

It is an object of the present invention to seek to alleviate the disadvantages associated with the prior art and to provide apparatus for use in the coating of articles. It is a further object of the present invention to provide an improved process of applying a coating to an article. It is a yet further object of the invention to provide a production line to apply a coating to an article.

### SUMMARY OF THE INVENTION

According to a first aspect of the invention there is provided a linkage member to link articles during a coating process, the linkage member having first and second ends each end being configured to receive and abut end portions of successive articles, to be coated and to prevent coating of said end portions.

Where the coating is thermoplastic or thermosetting, the linkage member is preferably formed from a material of low thermal conductivity to reduce energy transfer from the coating to the linkage member. Particularly preferred materials from which to form the linkage member are perfluorinated polymers, with polytetrafluoroethylenes especially preferred. The outer surface of the linkage member is optionally covered with a conductive material such as steel which is cheaper and has a greater longevity under in-use conditions than polytetrafluoroethylenes.

The linkage member conveniently has a circular cross section to minimise its surface area and reduce wastage of coating which might adhere to the linkage member.

The linkage member is preferably cylindrical, the diameter of the cylinder conveniently being 15 to 30 mm and the height 10 to 15 mm, to minimise the wastage of coating yet separate the products by a sufficient amount to reduce the reject rate when the linkage member is removed.

Where the linkage member is for use in linking tubular lamps, the first and second ends of the linkage member advantageously comprise recesses to receive the pins of a lamp. The recesses in the first end are preferably rotationally offset from those in the second end to reduce the overall required length of the linkage member. The linkage member may optionally comprise a recess to receive the end of the lamp.

According to the second aspect of the invention there is provided a method for coating an article, the method comprising the steps of;

i) drawing a leading portion of an article against a linkage member having first and second ends, each end being configured to receive and abut end portions of successive articles to be coated and to prevent coating of said end portions;

ii) feeding the linkage member and associated article(s) to a coating station, which includes an article coating machine;

iii) applying a coating to the or each article at the coating station;

iv) separating the linkage member from the or each coated article; and

v) conveying said article(s) to a stacking and/or packaging station.

Preferably, a second portion of the article is abutted against a second linkage member, before the article is fed into the coating machine. Conveniently, further articles and linkage members are alternately abutted against the second linkage member to form a chain. The further articles and linkage members are added at the same rate as the feed rate through the machine.

The invention includes within its scope a production line for coating articles incorporating linkage members as described herein, the production line having an article preparation station in which articles and linkage members are brought into engagement, a coating station in which articles are coated, a separating region in which coated articles are separated from the linkage members and a packaging station to package the coated articles.

### BRIEF DESCRIPTION OF THE DRAWINGS

The present invention will now be described more particularly with reference to the accompanying drawings which show, by way of example only, eight embodiments of a linkage member. In the drawings:

FIG. 1 is a longitudinal section through a first embodiment of a linkage member;

FIG. 2 is an end view of the linkage member shown in FIG. 1;

FIGS. 2a and 2b show end views of second and third embodiments of linkage members;

FIG. 2c shows a longitudinal section through a fourth embodiment of a linkage member.

FIG. 3 is a longitudinal section through a fifth embodiment of a linkage member;

FIG. 4 is a side view of a coated lighting tube and linkage member;

FIGS. 5 to 12 show longitudinal sections and end views of sixth to ninth embodiments of a linkage member;

FIG. 13 is a diagrammatic side view of apparatus for use in a coating process; and

FIG. 14 is a diagrammatic side view of the apparatus illustrated in FIG. 13.

### DETAILED DESCRIPTION OF THE INVENTION

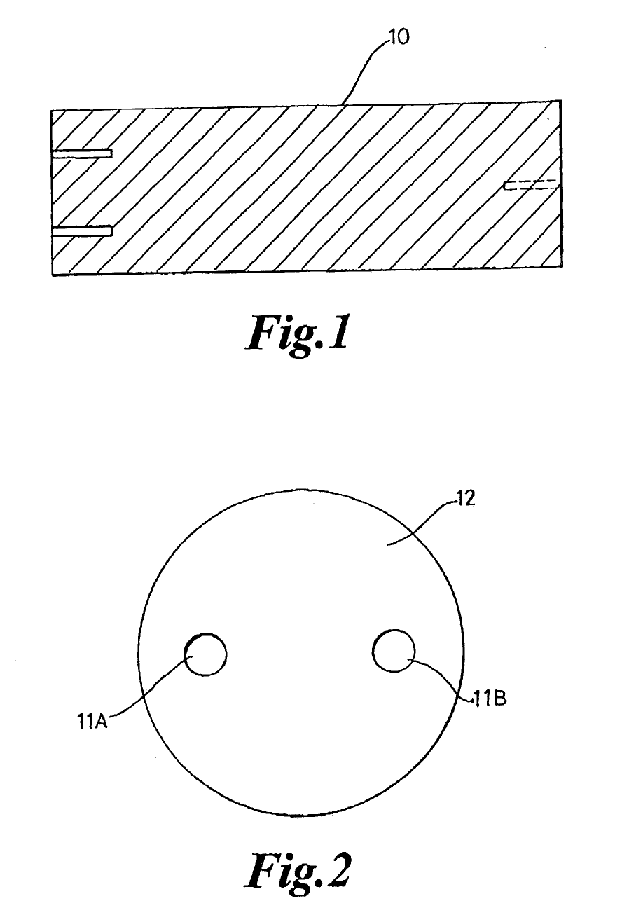

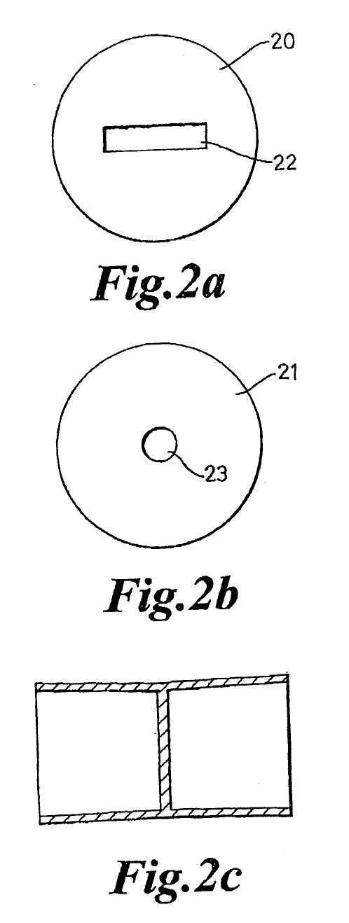

In FIGS. 1 and 2 a cylindrical linkage member 10, made of polytetrafluoroethylene has two holes 11A, 11B formed in each end face 12. The holes 11A, 11B are appropriately sized to receive the pins of certain types of tubular lamp.

FIGS. 2a and 2b show linkage members 20, 21 having respectively a rectangular recess 22 and a single cylindrical recess 23. The linkage members 20, 21 can therefore receive, where appropriate, the pins of tubular lamps having the pins corresponding to the recesses.

FIG. 2c shows a linkage member 25 having a tubular side wall 26. The internal space of the member 25 is divided into two volumes by a disc-shaped portion 27, integrally formed with the side wall 26. Each open end of the member 25 can therefore engage a tubular lamp.

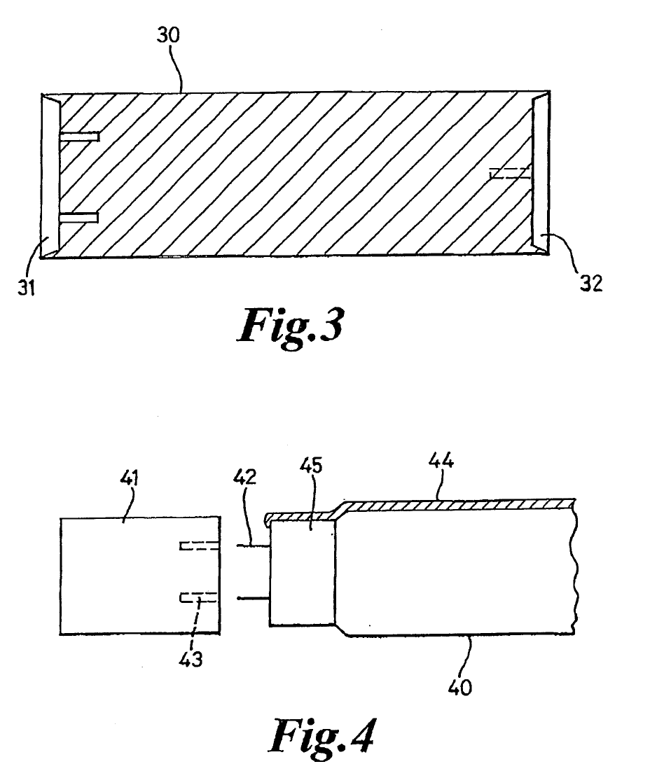

A further embodiment of the linkage member 30, shown in FIG. 3, has recesses, 31, 32 in each of the end faces of the cylinder to receive the end of a lamp and orientate the lamp into the correct position to receive a coating. In FIG. 4 the withdrawal of a lamp 40 from a linkage member 41 following coating of the lamp 40 is shown. The pins 42 of the lamp 40 are aligned with the holes 43 and the linkage member 41. The coating 44 extends onto the end face of the end cap 45 of the lamp 40. This can arise due to penetration of the coating 44 between the end of the lamp 40 and the linkage member 41 during coating. Alternatively, as the lamp 40 is withdrawn from the linkage member 41 the coating 44 on the linkage member 41 from the coating process, detaches from the linkage member 41 due to its limited bonding with the material from which the linkage member 41 is formed. As the lamp is withdrawn, the coating 44 forms around the end of the lamp 40.

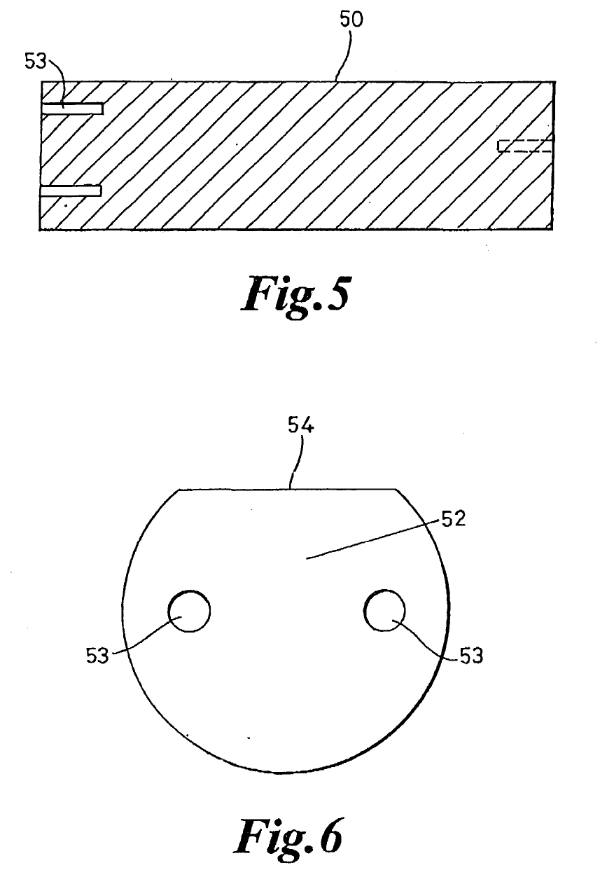

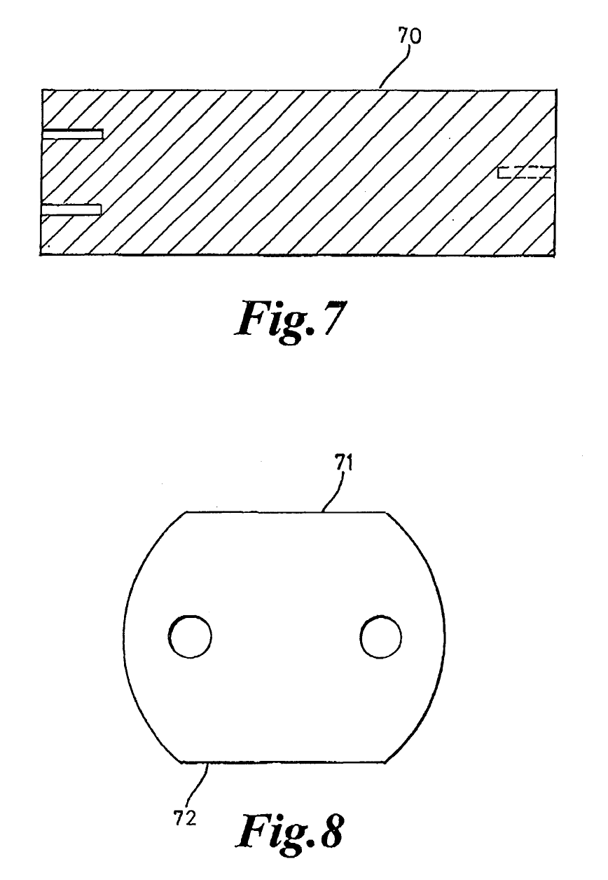

In FIGS. 5 and 6, a linkage member 50 is illustrated which is substantially cylindrical. The flat surface 52 of the linkage member 50 has two recesses 53 to receive pins. One of the surfaces 54, parallel to the main axis of the cylinder is flat. FIGS. 7 and 8 show a substantially cylindrical linkage member 70 having two flat surfaces 71, 72 on opposite sides of the cylinder. The flat surfaces 51, 71, 72 facilitate the use of the linkage members 50, 70 in an automated process by ensuring that the linkage members 50, 70 are correctly aligned with respect to a horizontal and vertical axis.

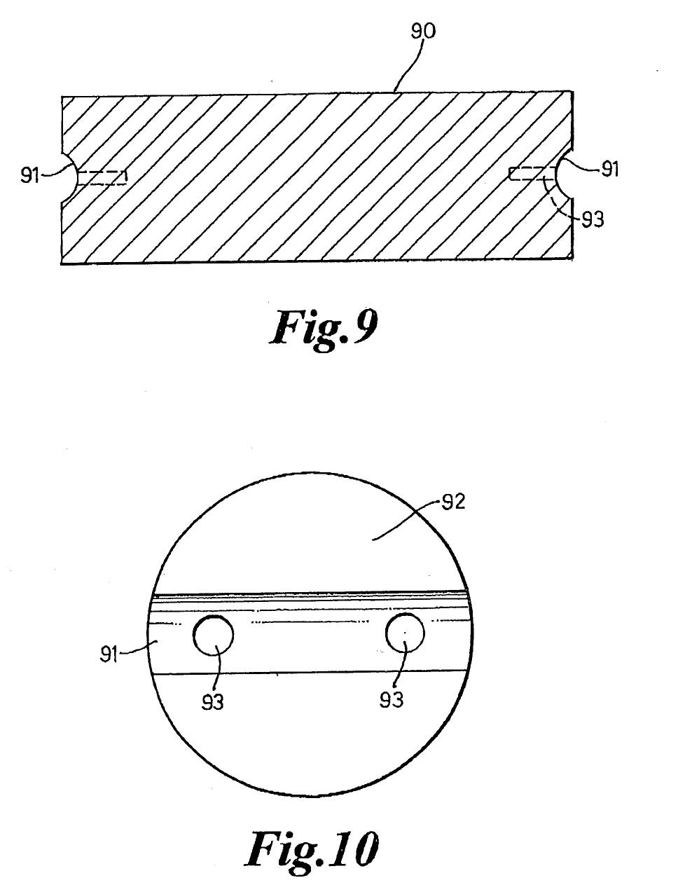

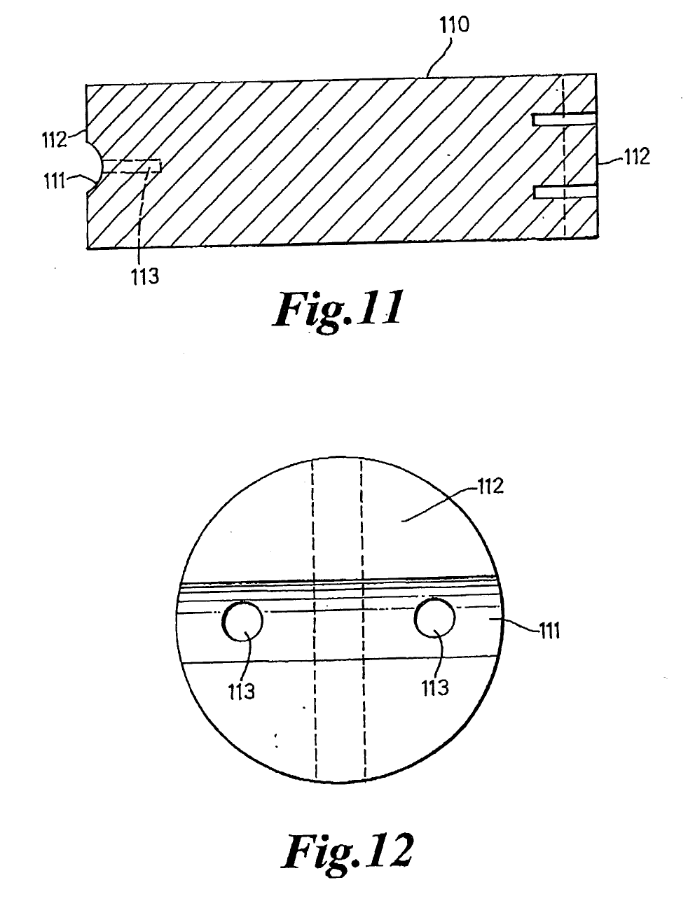

FIGS. 9 to 12 show substantially cylindrical linkage members 90, 110 in which rebates 91, 111 are cut into the flat surfaces 92, 112 of the linkage members 90, 110. The rebates 91, 111 further facilitate correct alignment of the article to be coated in the linkage member 90, 110, to ensure engagement of the pins on a tubular lamp with the recesses 93, 113.

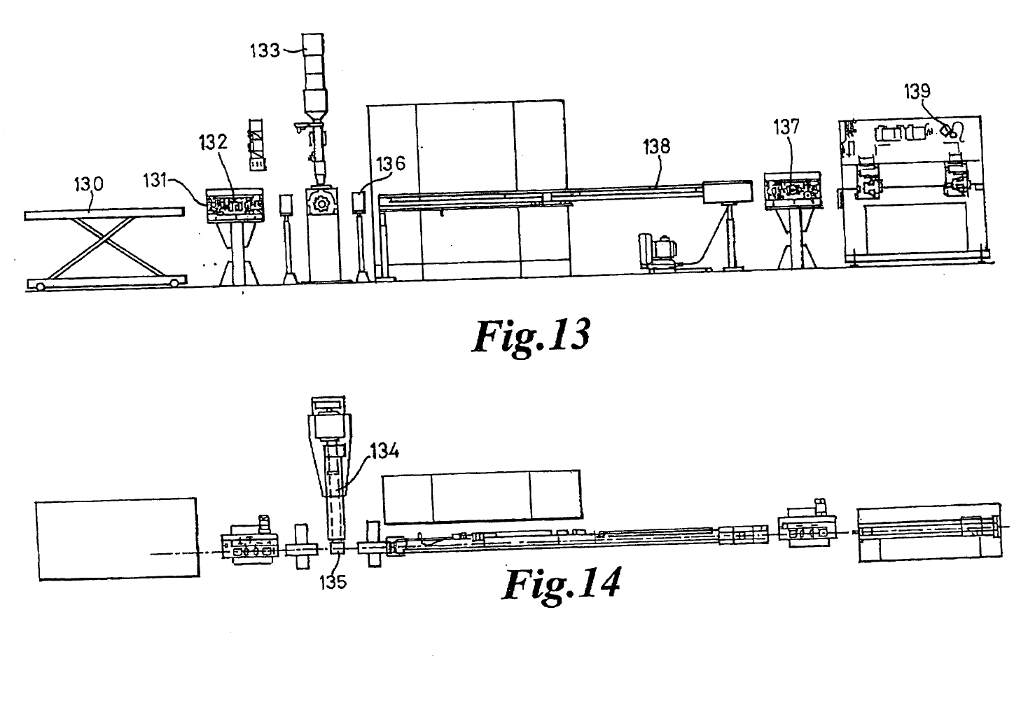

A suitable set of apparatus on which coating of tubular lamps is carried out is shown in FIGS. 13 and 14. The set of apparatus comprises a lamp handling table 130. A set of horizontally and vertically assembled pairs of guide pulleys 131 assist in guiding the lamps to a series of caterpillar belts 132. A caterpillar belt 132 is typically driven by a DC motor via a timing belt drive and a transmission gear box (not illustrated).

The caterpillar belts 132 are located against an extruder station in which coating material is applied. The extruder 134 comprises a vacuum hopper loader 133, from which solid polymeric material usually in the form of pellets is passed through to the extruder itself. The extruder 134 itself, is mounted at 90° to the line along which the lamps pass. In the extruder 134, the polymeric material is plasticised before being passed to a cross-head 135. The amount of material passing out of the extruder 134 and the rate of the caterpillar belts 132 is synchronised to ensure that the same mass of polymer per unit length of lamp-tubing is applied at the various line speeds at which the apparatus can operate. The cross-head 135 is so designed so that the polymer is distributed equally over the surface of the lamp-tube. This ensures that the coating is of identical wall thickness on all sides.

The tool fitted under the cross-head 135 corresponds in diameter to that of the lamp-tube being coated. A further series of caterpillar beds 137 are provided on the output side of the extruder station to assist motion of any lamp-tubes through the apparatus. An air-knife 138 cools the coating and the lamp-tubes once the coating has been applied. A cutting saw 139 comprising a rotating knife mounted inside a large ball-race (not illustrated) separates the lamp-tubes from one another. An aperture is provided in the centre of the ball-race to allow the lamp-tubes to pass through. A clamp (not illustrated) is also provided to clamp the lamp-tube to the cutting saw 139, the clamp travelling at the speed as the lamp-tube. Once the cut is finished, the clamps are released and the cutting saw 139 returns to its original position. To ensure that the cut is applied to the correct position a meter counter or a metal detector, locates the end-caps of the lamp-tubes. The individual lamp-tubes can then be removed by hand and further packaged.

In use, the lamp-tubes to be coated are stacked together on a receiving table. The lamp-tubes are loaded manually onto a conveyor belt, and once on the conveyor belt are coupled together in an end-to-end orientation by means of a plastic linkage member. The chain of lamp-tubes formed thereby is passed into a caterpillar feed, which feeds the chain into an extruder located at an angle of 90° to the feed direction. The extruder plasticises a predetermined mass of the polymer to be applied to the lamp-tube. The polymer is then passed through the cross-head component of the extruder. The cross-head is so designed to form a fully plasticised tube of polymer which is drawn over the lamp-tube onto its surface thus distributing the polymer equally across the whole surface of the lamp-tube. The even distribution ensures that the wall thickness of the coating is the same on all parts of the lamp-tube. At the joints, the plasticised polymer flows over the linkage member. When the linkage member is subsequently removed the coating material on the linkage member forms a shoulder over the end of the lamp-tube thus protecting this area. After leaving the extruder the coating is cooled by an air-knife.

A pull-out caterpillar pulls the chain of lamp-tubes out of the extruder. Throughout the process, the caterpillars and the extruder are synchronised. The synchronisation ensures that a smooth continuous coating is achieved with a consistent mass of polymer per unit length of lamp-tube, even if the line speed is varied.

Upon leaving the pull-out caterpillar, two simultaneous cuts are applied by a cutting saw on either side of the linkage member. The cutting saw comprises a rotating saw mounted inside a large ball-race through the centre of which ball-race the tubes pass. The position where the cut is to be made is determined by means of a meter counter or a metal detector which located the end-caps of the individual tubes. Whilst the cuts are being made, the cutting saw is clamped to the tubes and travels at the same rate as the tubes.

When the cuts have been made, the clamps holding the saw to the tubes are released and the cutting saw returns to its rest position. The linkage members can then be cleaned of any coating material adhering thereto and reused.

Using the apparatus and process described above, lamp-tubes having a diameter of from 15-30 mm in diameter and having a length of 2400 mm can be coated, although these values should not be taken as limiting. The thickness of the coating applied is chosen to suit the particular application of the lamp and the coating being applied but is typically between 0.2-0.3 mm. A production line will run at between 2-15 m/min.

The linkage members can be formed of materials which are capable of standing up to the temperatures of the plasticised polymer without melting or otherwise deforming. The materials from which the linkage members are formed also have low thermal conductivity to prevent their conducting heat away from the plasticised polymer and thereby affecting the setting process. Suitable materials from which the linkage member could be formed are a polytetrafluoroethylene or other perfluorinated polymers. The linkage member can have a thermally conducting outer surface, such as that provided by a coating, sleeve etc. of steel. Such an outer surface has the advantages that the outer surface material can be more hard wearing and long lasting than the inner core of the linkage member, and can also be substantially cheaper.

The linkage member need not have a shape which is substantially cylindrical, but can have for example a polygonal cross section such as a square, hexagon or octagon depending on the polymer to be used and the shoulder to be provided over the end-cap. The surface linking the two end-faces of the linkage member can also be profiled to alter the characteristics of the end-shoulder.

A linkage member can be 15-30 mm in diameter and most often 19 mm. The height of a linkage members is typically 10-15 mm, with 12.5 mm being particularly suitable.

Although the apparatus and process given have been described with reference to elongate fluorescent lamp tubes, it should not be taken as limiting the invention to use with said tubes. For example, other elongate articles can be coated to improve their safety or handling characteristics or to increase their useful lifetime by the application of a protective coating. For example, articles and equipment to be used in an aggressive environment such as outdoors, in a marine environment or within a chemical plant will benefit from the application of a protective layer. The apparatus and process can therefore be used, for example, to coat metal articles such as rods, cylinders, girders etc. The coating reduces the rate of degradation of the metal, principally by providing a barrier against oxidation, and so prolongs the life of the article.

Plastics materials and ceramics can also be coated when necessary. For example, chemical container, stirring rods and impellers, tubing etc. for use within a laboratory can be coated using the above described process and apparatus.

The overall process of loading the product on to the conveyor belt and removing the product for packaging can be handled manually or can be so adapted as to be performed mechanically, perhaps by means of a robot.

It can be contemplated that non-elongate articles can also be coated, a suitably shaped linkage member then being employed to protect one or more portions of the article.

It will of course be understood that the invention is not limited to the specific details described herein, which are given by way of example only, and that various modifications and alterations are possible within the scope of the invention.

1. A linkage member (10) to link articles during a coating process, the linkage member (10) having first and second ends (12), each end (12) being configured to receive and abut end portions of successive articles to be coated and to prevent coating of said end portions.

2. A linkage member according to claim 1, wherein the material from which the linkage member is formed from a material of low thermal conductivity to reduce energy transfer from the coating to the linkage member.

3. A linkage member according to claim 2, wherein the material is a perfluorinated polymer.

4. A linkage member according to any preceding claim, wherein the outer surface of the linkage member is covered with a conductive material such as steel.

5. A linkage member according to any preceding claim, wherein the linkage member has a circular cross section.

6. A linkage member according to any preceding claim, wherein the linkage member is cylindrical.

7. A linkage member according to claim 6, wherein the diameter of the cylinder is from being 15 to 30 mm.

8. A linkage member according to either of claims 6 or 7, wherein the height of the linkage member is from 10-15 mm.

9. A linkage member according to any preceding claim, wherein the first and second ends of the linkage member comprise recesses (11A, 11B) to receive the pins of a lamp.

10. A linkage member according to claim 9, wherein the recesses (11A, 11B) in the first end (12) are rotationally offset from those in the second end.

11. A linkage member according to any preceding claim, wherein the linkage member comprises a further recess (32) to receive the end of a lamp.

12. A method of coating an article, the method comprising the steps of;
i) drawing a leading portion of an article against a linkage member having first and second ends, each end being configured to receive and abut end portions of successive articles to be coated and to prevent coating, of said end portions;
ii) feeding the linkage member and associated article(s) to a coating station, which includes an article coating machine;
iii) applying a coating to the or each article at the coating station;
iv) separating the linkage member from the or each coated article; and
v) conveying said article(s) to a stacking and/or packaging station.

13. A method according to claim 12, wherein a second portion of the article is abutted against a second linkage member, before the article is fed into a coating machine.

14. A method according to claim 13, wherein further articles and linkage members are alternately abutted against the second linkage member to form a chain.

15. A method according to claim 14, wherein the further articles and linkage members are added at the same rate as the feed rate through the machine.

16. A linkage member substantially as herein described with reference to and as illustrated by the accompanying drawings.

17. A production line for coating articles incorporating linkage members as substantially described herein with reference to and as illustrated by FIGS. 13 and 14 of the accompanying drawings.
